(19) United States
(12) Patent Application Publication
(10) Pub. No.: US 2018/0361391 A1
(43) Pub. Date: Dec. 20, 2018

(54) COIL ARRANGEMENTS FOR METAL DETECTION IN UNDER-SINK DISPOSAL UNITS

(71) Applicant: SAMELIN INNOVATIONS, LLC, Wilmington, NC (US)

(72) Inventors: Michael STARKEY, Kent, OH (US); Lloyd S. RIGGS, Auburn, AL (US); Aubrey N. BEAL, Scottsboro, AL (US)

(21) Appl. No.: 16/012,786

(22) Filed: Jun. 20, 2018

Related U.S. Application Data
(60) Provisional application No. 62/522,687, filed on Jun. 20, 2017.
(60) Provisional application No. 62/554,548, filed on Sep. 5, 2017.

(51) Int. Cl. B02C 18/00; E03C 1/266; B02C 23/04; B02C 25/00

(52) U.S. Cl. CPC B02C 18/0092; B02C 25/00; B02C 23/04; E03C 1/2665

(57) ABSTRACT

An under-sink disposal unit includes a motor, a disposal chamber, and a passageway that extends from an opening in a top of the disposal unit to a grinding area of the disposal chamber. The disposal unit further includes a coil assembly comprising an arrangement of coils. The arrangement of coils is used to detect the passing of a metallic object in the passageway toward the grinding area of the disposal unit. The arrangement of coils comprises four pairs of coils, wherein each pair of coils comprises a transmit coil and a receive coil. The four pair of coils are arranged around an axis of the passageway and are offset relative thereto. Transmit coils located along a common axis are wound in the same direction such that the magnetic fields generated thereby augment the filed for detecting metallic objects passing toward the grinding area.

### CROSS-REFERENCE TO RELATED APPLICATION

The present application is a nonprovisional application of, and claims the benefit under 35 U.S.C. 119(e) to, U.S. provisional patent application 62/522,687 and U.S. provisional patent application 62/554,548. The present application incorporates by reference: U.S. patent application Ser. No. 13/843,400, and U.S. Pat. No. 8,584,976 issuing therefrom; U.S. patent application Ser. No. 14/823,940, and the publication thereof, i.e., U.S. patent application publication 2016/0040413; and U.S. patent application 62/522,687.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

Under-sink disposals are commonly found in most U.S. homes, and are designed to shred organic material prior to entering a sewer system. Such disposals are not designed to handle bottle caps, jar lids, or utensils such as a knife, fork, or spoon, let alone the occasional piece of jewelry, such as a wedding ring. Indeed, when such items are inadvertently dropped or otherwise fall into the disposal, the disposal may become damaged or break, the item may become damaged or destroyed, or both.

To address this, the incorporated disclosures of the above references disclose the use of metal detection in under-sink disposal units, wherein grinding operation is disabled upon detection of metal passing toward the grinding area. Additionally, specific coil arrangements for use in metal detection in under-sink disposal units also are disclosed in U.S. patent application Ser. No. 14/896,435, and U.S. Pat. No. 9,694,364 issuing therefrom, the disclosure of each of which is incorporated herein by reference. The present invention relates to further coil arrangements for use in metal detection in under-sink disposal units, which coil arrangements are believed to have on or more certain advantages over those of the incorporated disclosures of these references.

### SUMMARY OF THE INVENTION

The present invention generally relates to apparatus and methods for detecting unintended objects in under-sink disposals—including both ferrous and non-ferrous objects—that pass from a sink toward a grinding area of an under-sink disposal unit, and in particular, to particular coil arrangements for use in metal detection in under-sink disposal units. Moreover, the present invention includes many aspects and features.

In an aspect of the invention, an under-sink disposal unit includes a motor, a disposal chamber, and a passageway that extends from an opening in a top of the disposal unit to a grinding area of the disposal chamber. The disposal unit further includes a coil assembly comprising an arrangement of coils. The arrangement of coils is used to detect the passing of a metallic object in the passageway toward the grinding area of the disposal unit.

In accordance with this aspect, the arrangement of coils comprises a plurality of coils including two or more transmit coils and two or more receive coils, wherein: the transmit coils are electrically coupled and the receive coils are not electrically coupled; each transmit coil comprises a plurality of loops (i.e., windings) which are all in the same direction; and the transmit coils are approximately the same shape and size and, preferably, are identical. Each coil also preferably is oriented with respect to an axis of the passageway such that objects passing through the passageway toward the disposal chamber pass by and proximate to, but do not pass through, the loop of the coil. Furthermore, in a feature, each coil in the disposal unit is oriented such that, with respect to an axis of the passageway, an object passing through the passageway toward the disposal chamber does not pass through any loop of such coil.

In a feature, the transmit coils preferably are arranged so as to augment the magnetic fields created thereby, and are electrically coupled so as to be in phase. The electrical coupling of the transmit coils preferably is accomplished by using a single, electrically conductive wire to form the transmit coils.

In another feature, the transmit coils preferably are located on opposite sides of the passageway, with a receive coil located with each transmit coil. Moreover, each transmit coil on a side of the passageway preferably bounds at least an upper portion and a lower portion of a receive coil.

In another feature, the transmit coils preferably are located on opposite sides of the passageway.

In a second aspect of the invention, an under-sink disposal unit includes a motor, a disposal chamber, and a passageway that extends from an opening in a top of the disposal unit to a grinding area of the disposal chamber. The disposal unit further includes a coil assembly comprising an arrangement of coils. The arrangement of coils is used to detect the passing of a metallic object in the passageway toward the grinding area of the disposal unit. In accordance with this aspect, the arrangement of coils comprises two transmit coils that are offset from an axis of the passageway insofar as the center points of the transmit coils are not equidistant from the axis of the passageway.

In another aspect of the invention, an under-sink disposal unit includes a motor, a disposal chamber, and a passageway that extends from an opening in a top of the disposal unit to a grinding area of the disposal chamber. The disposal unit further includes a coil assembly comprising an arrangement of coils. The arrangement of coils is used to detect the passing of a metallic object in the passageway toward the grinding area of the disposal unit.

In accordance with this aspect, the arrangement of coils comprises two transmit coils that are offset from an axis of the passageway insofar as the center points of the transmit coils are not equidistant from the axis of the passageway.

In a feature, the arrangement of coils comprises of a plurality of coils, each of which includes a loop that is oriented with respect to an axis of the passageway such that objects passing through the passageway to the grinding area of the disposal chamber pass by and proximate to, but do not pass through, such loop.

In another feature, the arrangement of coils comprises of a plurality of coils, none of which includes a loop that is oriented with respect to an axis of the passageway through the passageway such that objects passing therethrough into the grinding area pass through such loop.

In another aspect of the invention, an under-sink disposal unit includes a motor, a disposal chamber, and a passageway that extends from an opening in a top of the disposal unit to a grinding area of the disposal chamber. The disposal unit further includes a coil assembly comprising an arrangement of coils. The arrangement of coils is used to detect the passing of a metallic object in the passageway toward the grinding area of the disposal unit. In accordance with this aspect, the arrangement of coils comprises two receive coils that are offset from an axis of the passageway insofar as the center points of the transmit coils are not equidistant from the axis of the passageway.

In still another aspect of the invention, an under-sink disposal unit includes a motor, a disposal chamber, and a passageway that extends from an opening in a top of the disposal unit to a grinding area of the disposal chamber. The disposal unit further includes a coil assembly comprising an arrangement of coils. The arrangement of coils is used to detect the passing of a metallic object in the passageway toward the grinding area of the disposal unit. In accordance with this aspect, the arrangement of coils comprises two pairs of coils—each pair comprising a receive coil and a transmit coil—wherein the two pairs of coils are offset from an axis of the passageway insofar as the center points of the two pairs of coils are not equidistant from the axis of the passageway.

In still yet another aspect, a method of installing an under-sink disposal unit includes the steps of: providing an under-sink disposal unit as disclosed herein; connecting power to the motor of the disposal unit such that the power is toggled by a user activated switch; and connecting power to electronics of the under-sink disposal unit that actively detects passing of a metallic object toward the grinding area, and that cuts power to the motor of the disposal unit upon the detection of a metallic object.

In an aspect, an under-sink disposal installation comprises a sink; and an under-sink disposal unit as disclosed herein.

Still further features of the present invention are disclosed in the disclosures of the incorporated references above.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 is a perspective view of a disposal unit.

FIG. 1A is a shaded view of FIG. 1.

FIG. 2 is a perspective view of the disposal unit of FIG. 1 in which some components are omitted for clarity of illustration.

FIG. 2A is a shaded view of FIG. 2.

FIG. 3 is a perspective view of the disposal unit of FIG. 2 in which some additional components are omitted for clarity of illustration.

FIG. 3A is a shaded view of FIG. 3.

FIG. 4 is a schematic illustration of a coil arrangement of the disposal unit of FIG. 1.

FIG. 5 is a schematic illustration of an alternative coil arrangement of the disposal unit of FIG. 1.

FIG. 6 is a schematic illustration of another alternative coil arrangement of the disposal unit of FIG. 1.

### DETAILED DESCRIPTION

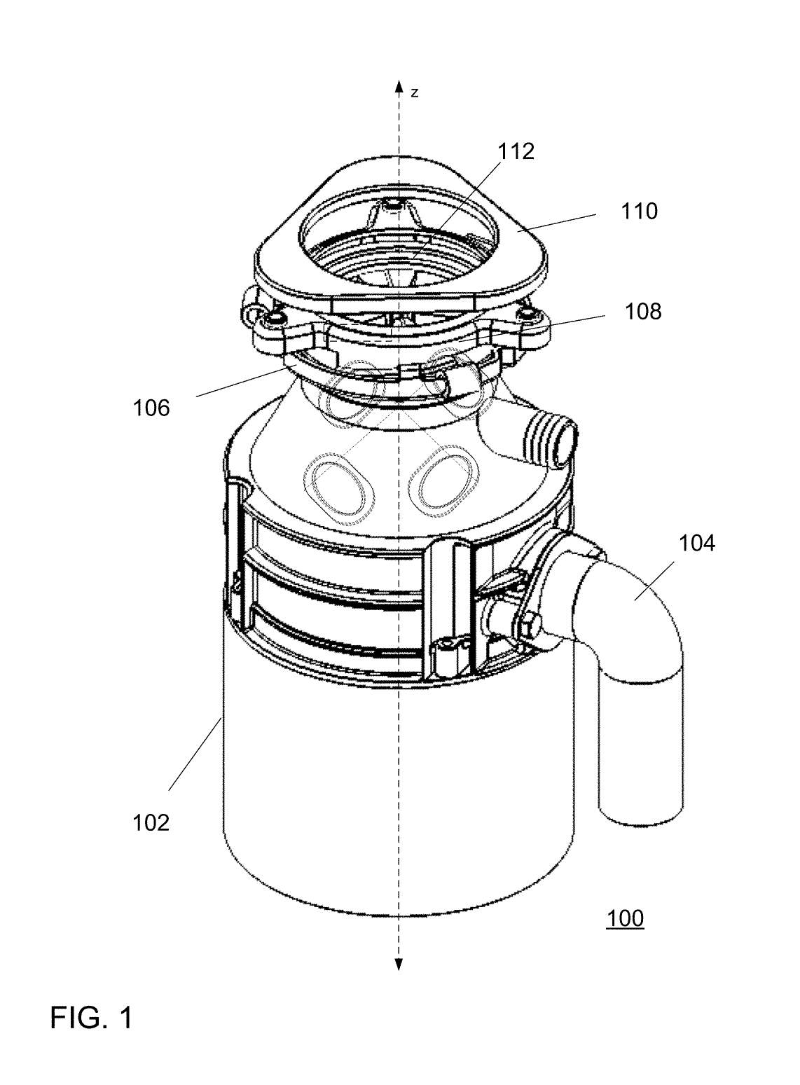

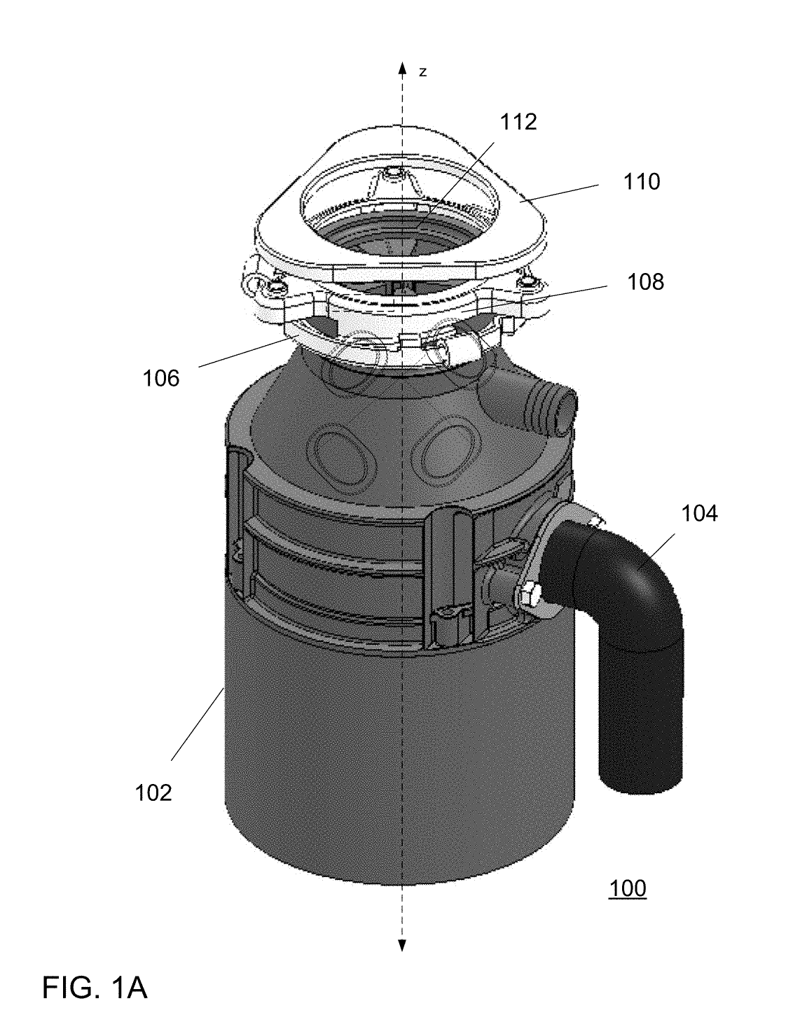

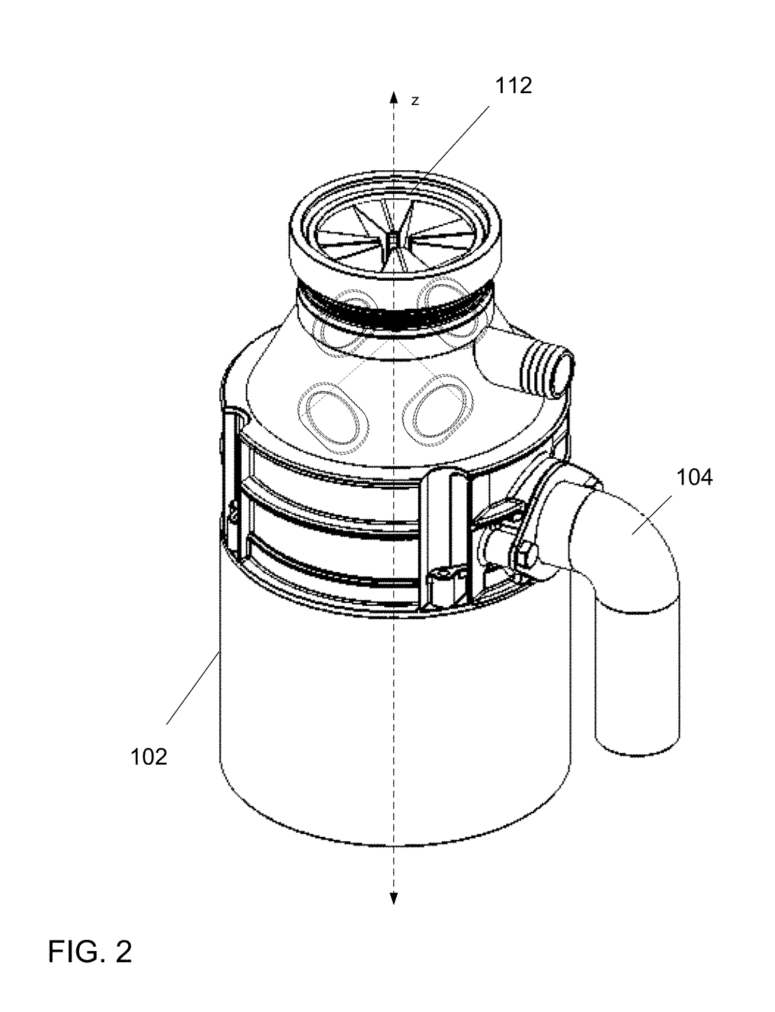

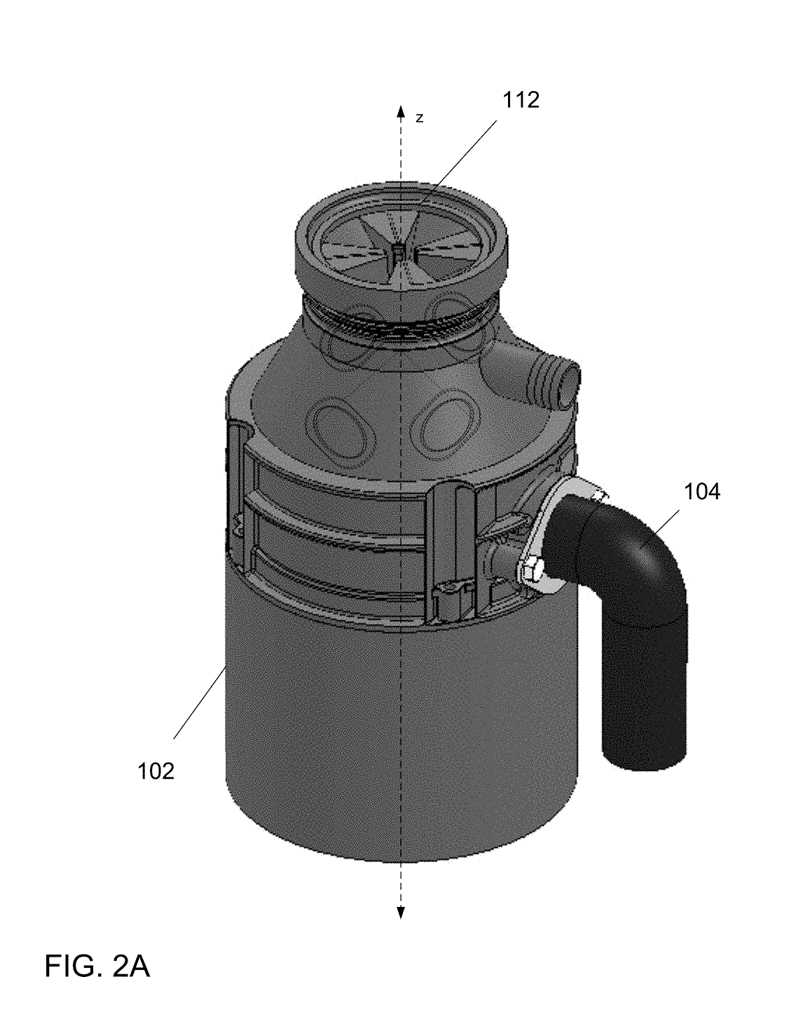

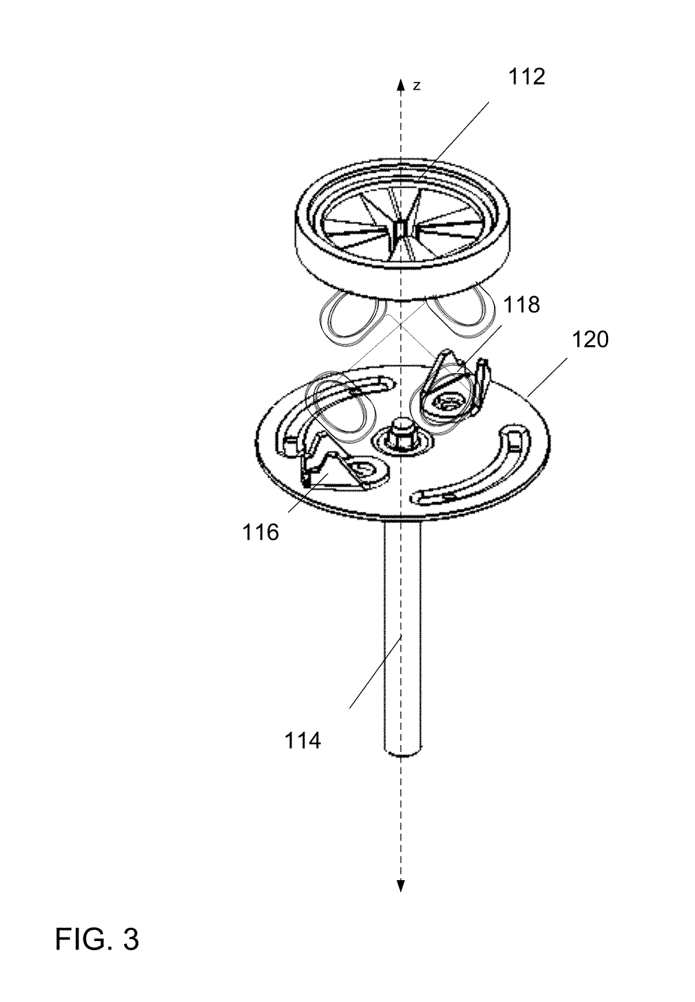

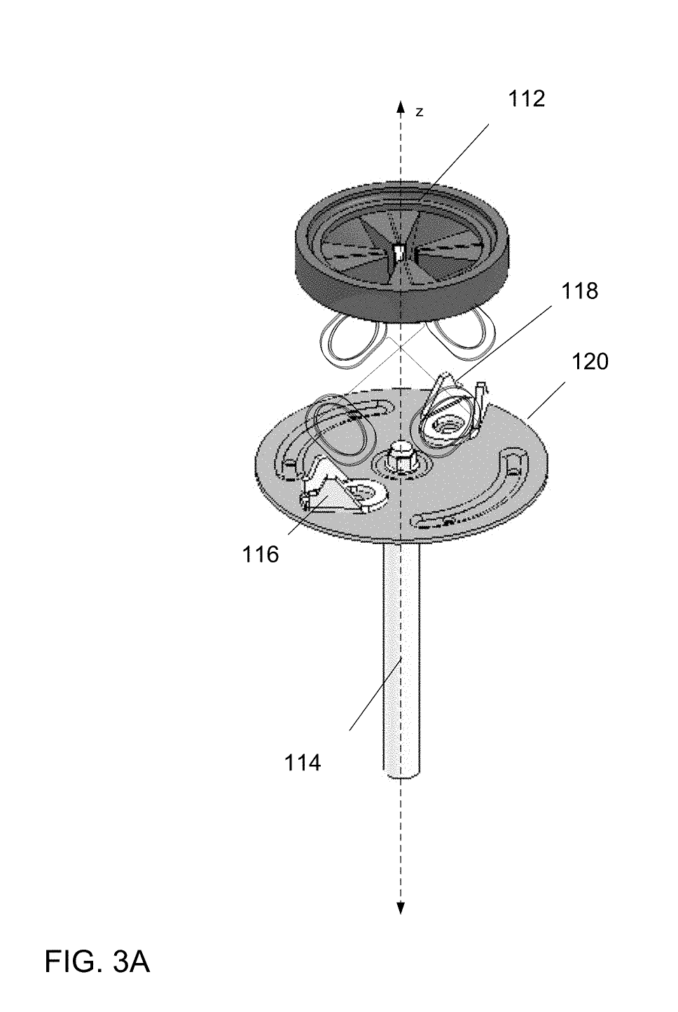

FIG. 1 is a perspective view of a disposal unit 100, and FIG. 1A is a shaded view of the disposal unit 100. Similarly, FIG. 2 is a perspective view of the disposal unit 100 of FIG. 1 in which some components are omitted for clarity of illustration, and FIG. 2A is a shaded view thereof; FIG. 3 is a perspective view of the disposal unit 100 of FIG. 2 in which some additional components are omitted for clarity of illustration, and FIG. 3A is a shaded view thereof.

The disposal unit 100 is representative of major components of disposal units used in various preferred embodiments of the invention. As shown in FIGS. 1 and 2, components of the disposal unit 100 include a disposal body 102, a tailpipe 104, a disposal body flange 106, a mounting ring 108, a backup ring 110, and a mounting gasket 112. As shown in FIG. 3, components used in shredding of waste in a shredding area of a disposal chamber during operation of the disposal unit 100 include a body axle 114, grinding tooth 116, grinding tooth 118, and end frame 120. Preferred embodiments of aspects and features of the invention are now described in detail within the context of components of disposal units as represented by disposal unit 100.

As will be appreciated, the disposal includes a passageway that extends from an opening in a top of the disposal unit to a grinding area of the disposal chamber. The body axle 114 extends along an axis z of this passageway. The disposal unit 100 further includes a coil assembly comprising an arrangement of coils. The arrangement of coils is used to detect the passing of a metallic object toward the grinding area of the disposal unit.

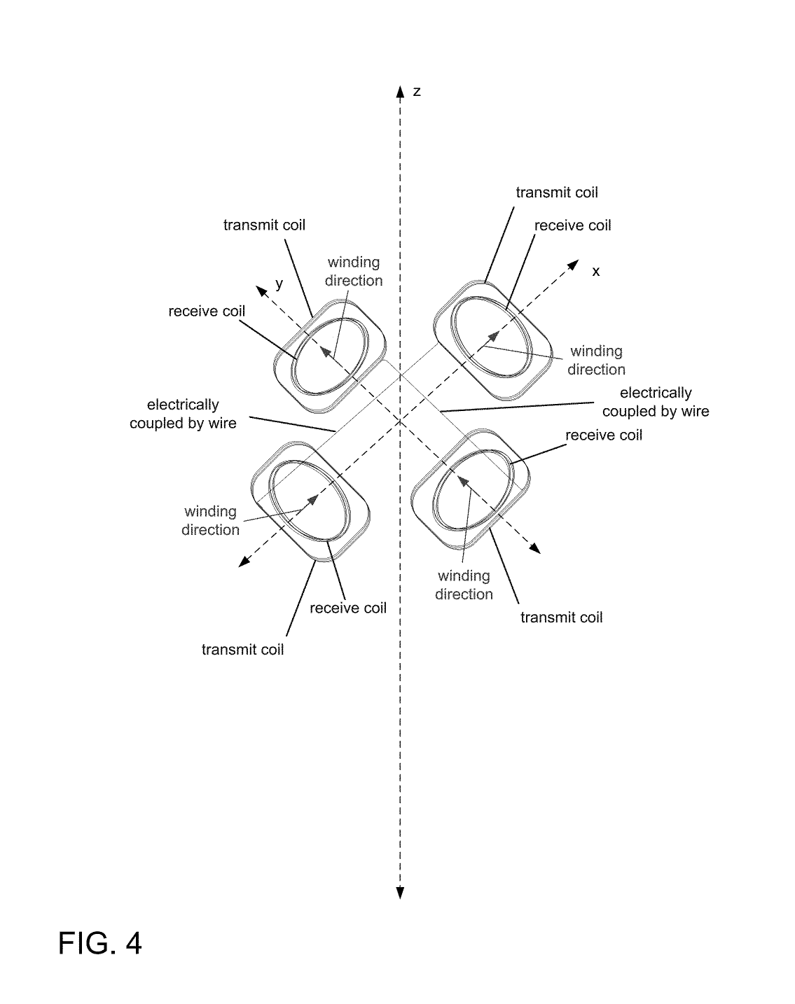

As seen in FIGS. 1-4, the arrangement of coils comprises a plurality of coils including two or more transmit coils and two or more receive coils. Specifically, the arrangement of coils in FIGS. 1-4 comprises four pair of coils. Each pair comprises a transmit coil and a receive coil, and two pairs are opposed on the x axis and two pairs are opposed along the y axis. These coils are shown in phantom in FIGS. 1-2A, and are shown relative to the orthogonal axes x,y,z in FIG. 4.

With particular regard to FIG. 4, the arrangement of the coil pairs relative to the axis z is seen to be equidistance, insofar as each coil pair is located from the axis z the same distance within the x-y plane. Furthermore, each coil pair is oriented with respect to the z axis such that objects passing through the passageway toward the disposal chamber in the disposal unit pass by and proximate to, but do not pass through, any loop of any of the coils in the arrangement.

Furthermore, as perhaps best seen here, each transmit coil and receive coil comprises a plurality of loops or windings. Preferably, each coil comprises between 2 and 50 loops or windings. Additionally, the transmit coils are approximately the same shape and size, and preferably the transmit coils are identical. The receive coils also are approximately the same shape and size, and preferably the receive coils are identical.

As further seen in FIG. 4, the transmit coils along the x axis are electrically coupled and the corresponding receive coils are not electrically coupled; and the transmit coils along the y axis are electrically coupled and the corresponding receive coils are not electrically coupled.

Additionally, the transmit coils are located on opposite sides of the z axis, and each transmit coil along an axis (i.e., the x axis or the y axis) preferably is formed by windings that extend in the same direction, whereby the magnetic fields created by the transmit coils along the axis are augmented. In this respect, the transmit coils are electrically coupled so as to be in phase. The electrical coupling of the transmit coils preferably is accomplished by using a single, electrically conductive wire to form all of the transmit coils that are located along a common axis.

With further respect to the coil pairs of the coil arrangement, each receive coil is located with a corresponding transmit coil, with the corresponding transmit coil bounding at least an upper portion and a lower portion of the receive coil and, as illustrated, bounding the entirety of the receive coil.

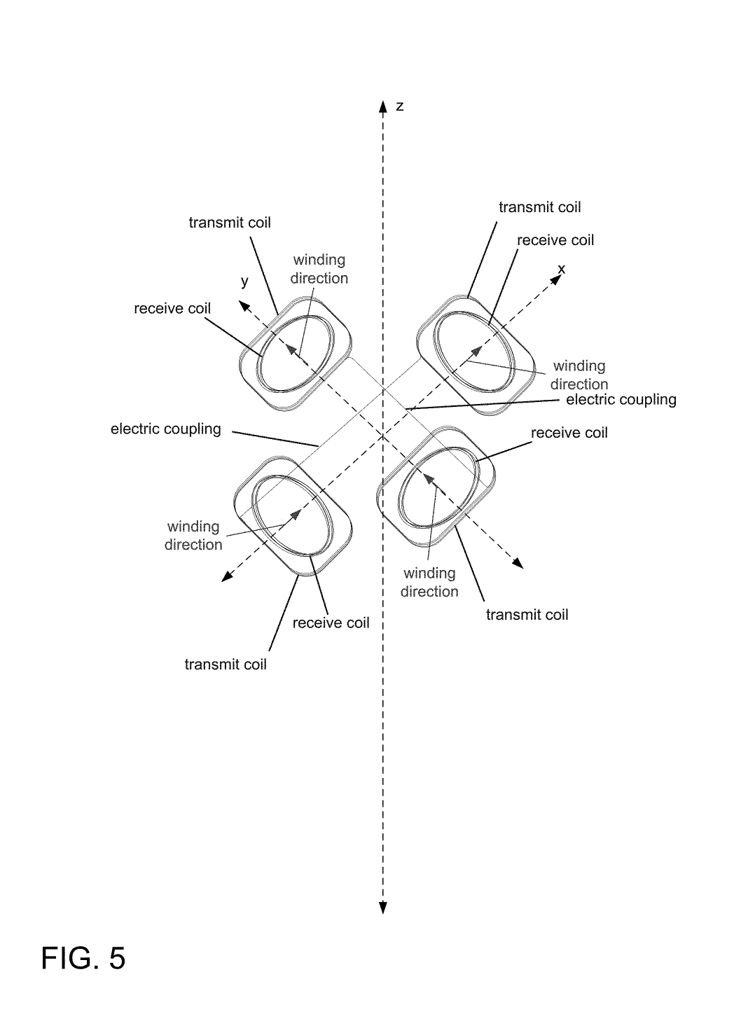

FIG. 5 illustrates an alternative coil arrangement. This coil arrangement is similar to that of FIG. 4, with the exception that the opposed coil pairs along they axis are offset relative to the origin or z axis, with one coil pair on the y axis being further from the origin or z axis than the other coil pair on the y axis. In other words, the coil pairs are offset insofar as the center points of the transmit coils along the y axis are not equidistant from the z axis, and the center points of the receive coils along the y axis are not equidistant from the z axis. This shift along the y axis is believed to shift the field characteristics along the y axis.

Likewise, while not show, another alternative coil arrangement is similar to that of FIG. 4, with the exception that the opposed coil pairs along the x axis are offset relative to the origin or z axis, with one coil pair on the x axis being further from the origin or z axis than the other coil pair on the x axis. In other words, the coil pairs are offset insofar as the center points of the transmit coils along the x axis are not equidistant from the z axis, and the center points of the receive coils along the x axis are not equidistant from the z axis. This shift along the x axis is believed to shift the field characteristics along the x axis.

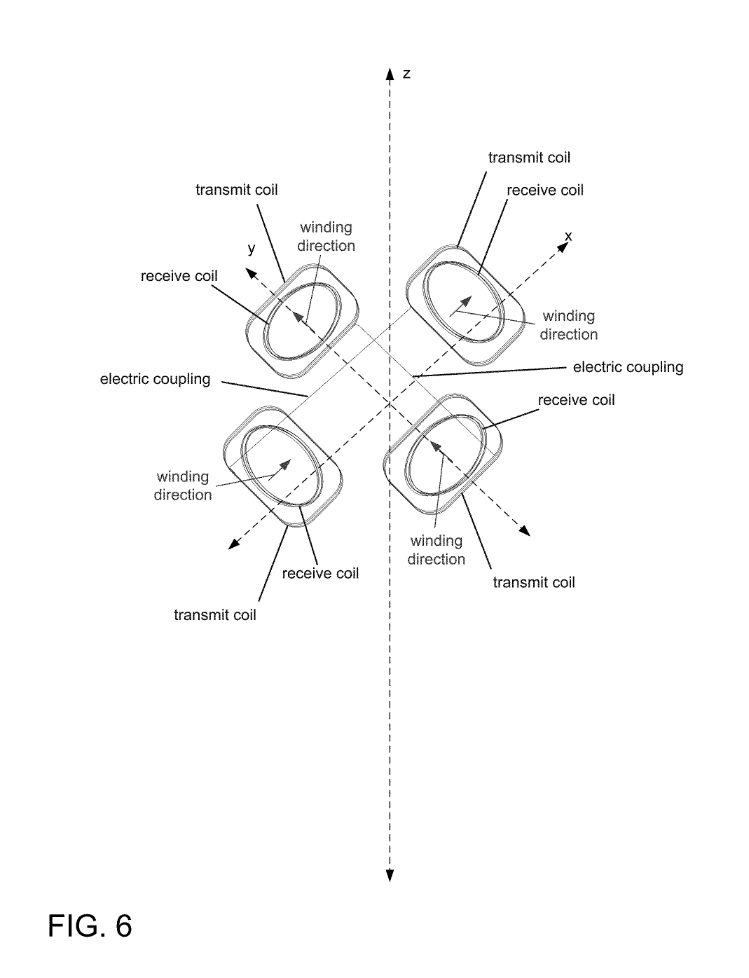

FIG. 6 illustrates still yet another alternative coil arrangement. This coil arrangement is similar to the arrangement of coils seen in FIG. 4, with the exceptions that the opposed coil pairs along the y axis are offset relative to the origin or z axis, with one coil pair on the y axis being further from the origin or z axis than the other coil pair on the y axis; and that the opposed coil pairs along the x axis are offset relative to the origin or z axis, with one coil pair on the x axis being further from the origin or z axis than the other coil pair on the x axis. In other words, the coil pairs along the y axis are offset insofar as the center points of the transmit coils along the y axis are not equidistant from the z axis, and the center points of the receive coils along the y axis are not equidistant from the z axis; and the coil pairs along the x axis are offset insofar as the center points of the transmit coils along the x axis are not equidistant from the z axis, and the center points of the receive coils along the x axis are not equidistant from the z axis. This shift along the x axis is believed to shift the field characteristics along the x axis. This shift along the y axis is believed to shift the field characteristics along the y axis.

The aforementioned offsetting is believed to move areas of field cancelation away from z axis, i.e., the axis of the passageway through the disposal unit, resulting in an increase in the sensitivity of the detection of a metallic object passing toward the grinding area of the disposal unit. Indeed, it is currently believed that the coil arrangement of FIG. 4 may have a dead spot or otherwise significant drop in sensitivity in detection at the origin, i.e., intersection, of the illustrated axes. Shifting of this possible dead spot is believed to increase the performance and detection of metallic objects, which are believed to more likely fall along the center of the passageway, i.e., the z axis, than along a side of the passageway.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. For instance, while preferred embodiments have been described within the context of residential use, it is believed that the present invention has applicability to use with commercial disposal units as well.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. An under-sink disposal unit, comprising a motor, a disposal chamber, and a passageway that extends from an opening in a top of the disposal unit to a grinding area of the disposal chamber, and further comprising
(a) a coil assembly comprising an arrangement of coils,
(b) wherein the arrangement of coils is used to detect the passing of a metallic object in the passageway when passing from the opening in the top of the disposal unit to the grinding area, and
(c) wherein the arrangement of coils comprises a plurality of coils including two or more transmit coils and two or more receive coils, wherein: the transmit coils are electrically coupled and the receive coils are not electrically coupled; and each transmit coil comprises a plurality of loops (i.e., windings) which are all in the same direction.

2. The under-sink disposal unit of claim 1, wherein the transmit coils are approximately the same shape and size.

3. The under-sink disposal unit of claim 1, wherein the transmit coils are identical.

4. The under-sink disposal unit of claim 1, wherein each coil is oriented with respect to an axis of the passageway such that objects passing through the passageway toward the disposal chamber pass by and proximate to, but do not pass through, the loop of the coil.

5. The under-sink disposal unit of claim 1, wherein each coil in the disposal unit is oriented such that, with respect to an axis of the passageway, an object passing through the passageway toward the disposal chamber does not pass through any loop of such coil.

6. An under-sink disposal unit, comprising a motor, a disposal chamber, and a passageway that extends from an opening in a top of the disposal unit to a grinding area of the disposal chamber, and further comprising
(a) a coil assembly comprising an arrangement of coils,
(b) wherein the arrangement of coils is used to detect the passing of a metallic object in the passageway when passing from the opening in the top of the disposal unit to the grinding area, and
(c) wherein the arrangement of coils comprises two coils that are offset from an axis of the passageway insofar as the center points of the coils are not equidistant from the axis of the passageway.

7. The under-sink disposal unit of claim 6, wherein the two offset coils are transmit coils.

8. The under-sink disposal unit of claim 6, wherein the two offset coils are receive coils.

9. An under-sink disposal unit, comprising a motor, a disposal chamber, and a passageway that extends from an opening in a top of the disposal unit to a grinding area of the disposal chamber, and further comprising
(a) a coil assembly comprising an arrangement of coils,
(b) wherein the arrangement of coils is used to detect the passing of a metallic object in the passageway when passing from the opening in the top of the disposal unit to the grinding area, and
(c) wherein the arrangement of coils comprises two pairs of coils—each pair comprising a receive coil and a transmit coil—wherein the two pairs of coils are offset from an axis of the passageway insofar as the center points of the two pairs of coils are not equidistant from the axis of the passageway.
